(19) United States
(12) Patent Application Publication
(10) Pub. No.: US 2006/0187024 A1
(43) Pub. Date: Aug. 24, 2006

(54) Portable security system

(76) Inventors: Kouros Azimi, Center Valley, PA (US); John A. Michejda, Berkeley Heights, NJ (US); Scott W. McLellan, Kempton, PA (US)

Correspondence Address: William S. Francos;VOLENTINE FRANCOS & WHITT, PLLC., One Freedom Square, Suite 1260, 11951 Freedom Drive, Reston, VA, 20190, US

(21) Appl. No.: 11/053,013

(22) Filed: Feb. 8, 2005

(51) Int. Cl. G08B 1/08; G08B 25/00; G08B 13/00

(52) U.S. Cl. 340/539.1; 340/524; 340/541; 340/539.22

(57) ABSTRACT

A portable security system includes a portable wireless link and a portable motion sensor, which is adapted to receive control signals from the portable wireless link, and which is adapted to communicate a signal when a security breach occurs. A method of providing security is also described.

### BACKGROUND

Personal security remains a concern in many parts of the world. Many households include security systems to prevent harm to persons, or theft of property, or both. Unfortunately, known home security systems are not portable. Thus, when people leave home, they risk injury to their person, or theft of their property, or both.

For example, people often travel away from home and stay in hotels or similar accommodations. Moreover, many people live in apartments, dormitories and similar rental units. Often, these types of dwellings do not include security systems that are found in many homes.

Many hotels have taken measures in an attempt to eliminate unauthorized entry into guests' rooms. One such measure is to provide each guest with a key card that is programmed with a new code when a guest checks into the hotel, thus preventing duplication of or unauthorized use of keys by would-be intruders. In addition, some hotels, dormitories and apartments use closed circuit cameras linked to a guard station to monitor suspicious activity in an effort to prevent crime.

Moreover, many hotels, dormitories and apartments also have security personnel on duty to watch for suspicious individuals or activity on the premises.

Unfortunately, in spite of the noted attempts to deter and prevent crime to person and property, such crimes still occur daily.

What is needed, therefore, is a security system that overcomes at least the shortcomings of the systems described above.

### SUMMARY

In accordance with an example embodiment, a portable security system includes a portable wireless link. The portable security system also includes a portable motion sensor, which is adapted to receive control signals from the portable wireless link, and which is adapted to communicate a signal when a security breach occurs. Additionally, the portable security systems includes a memory, which is adapted to receive a code indicating the location of the portable motion sensor.

In accordance with another example embodiment, a method of providing security includes providing a portable wireless link and a portable motion sensor and transmitting control signals from the portable wireless link. The method also includes providing a code to the portable wireless link, wherein the code includes a location of the portable motion sensor. In addition, the method includes communicating a signal from the portable wireless link when a security breach occurs.

### BRIEF DESCRIPTION OF THE DRAWINGS

The example embodiments are best understood from the following detailed description when read with the accompanying drawing figures. It is emphasized that various features are not necessarily drawn to scale. In fact, the dimensions may be arbitrarily increased or decreased for clarity of discussion.

FIG. 1 is a conceptual diagram of a portable security system in accordance with an example embodiment.

FIG. 2 is a diagram of a portable security system in accordance with another example embodiment.

FIG. 3 is a diagram of a portable security system in accordance with another example embodiment.

### DETAILED DESCRIPTION

In the following detailed description, example embodiments disclosing specific details are set forth in order to provide an understanding of the present invention. The example embodiments are set forth for purposes of explanation and not limitation. Those of ordinary skill in the art will understand that various changes in form and details may be made to the example embodiments without departing from the scope of the present invention. Moreover, descriptions of well-known devices, methods, systems, and and protocols may be omitted so as to not obscure the description of the example embodiments. Nonetheless, such devices, methods, systems and protocols that are within the purview of those of ordinary skill in the art are contemplated by the example embodiments.

Briefly, and as described in conjunction with example embodiments herein, a portable security system comprises a portable wireless link and a portable motion sensor. Usefully, the personal motion sensor is adapted to receive control signals from the personal wireless link. When the portable motion sensor is activated, the portable wireless link is caused to transmit an alarm signal indicating that a security breach has occurred. In some cases, the security system further comprises an audible alarm indicating that a security breach has occurred. Beneficially, the location of the portable motion sensor is provided to the security personnel, who can render aid.

Specific details will now be set forth with respect to example embodiments depicted in the attached drawings. It is noted that like reference numerals refer to like elements.

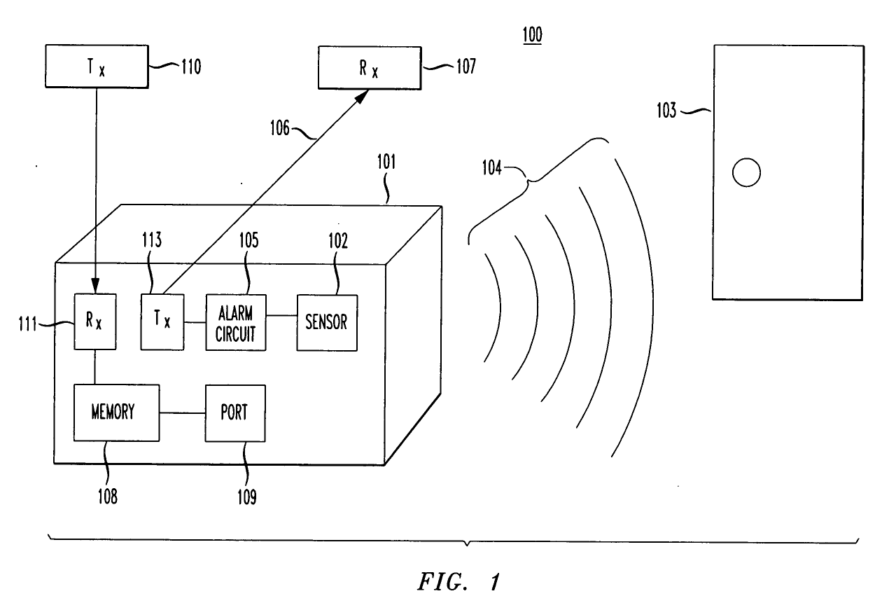

FIG. 1 is a block diagram of a portable security system 100 in accordance with an example embodiment. The portable security system 100 includes a portable wireless link 101 and a portable motion sensor 102. Illustratively, the portable security system 100 is disposed in proximity to an entry to a room, depicted by a door 103. For example, the portable security system 100 could be located on a table (not shown) or on the floor (not shown) adjacent to the door 103.

When security is desired, the user presses a designated button or code on a keypad (not shown) on the portable wireless link 101, which sends a control signal from the portable wireless link 101 to the portable motion sensor to engage the system 100. The control signal may be transmitted from the portable wireless link via the circuitry of the system 100, or in a wireless manner.

Illustratively, two bits of memory are shared by the portable wireless link 105 and the portable motion sensor 102. A first bit allows the portable wireless link 105 to provide the control signal to the portable motion sensor 102 to engage or disengage. A second bit allows the portable motion sensor 102 to signal to the portable wireless link 101 when it is activated because of an intruder or other security breach.

It is emphasized that the referenced process for activity and implementing the personal wireless system 100 is merely a teaching example and those of ordinary skill in the art will understand that there are alternative ways to activate and implement the integrated unit. Moreover, the control signal may be used to effect other modes of operation in the system. For example, the control signal may be used to alter the sensitivity or breadth of the portable motion sensor 102.

In operation, when the security system 100 is engaged, the portable motion sensor 102 emits a beam 104. If the door is opened or other motion occurs within the breadth of the beam 104, the beam 104 is disturbed and this disturbance is detected by the portable motion sensor 102. The second bit is sent to alarm circuitry 105, which is electrically connected to the sensor 102. The alarm circuitry 105 triggers a transmitter 112. The transmitter 112 then transmits a signal 106 to a receiver 107, for example at a security office.

As will become clearer as the present description continues, the signal 106 includes a code that identifies the location of the portable security system 100. Illustratively, the code identifies the room of the guest to the hotel security personnel; or the apartment of the lessee in an apartment to the police or security personnel; or dormitory to the police or security personnel. For example, when a certain code number is transmitted to alert the hotel security, hotel security personnel are able to identify the name and room number of the guest corresponding to the code number that was transmitted. Likewise, when the code number is transmitted to alert the police or security department, the name and apartment/dormitory room number of the lessee corresponding to the code are identified. Thus, after the receipt of the signal 106, security personnel can respond directly to the location of the portable security system 100 and thus render aid.

In the example embodiment described in connection with FIG. 1, the portable security system 100 is an integral unit. The integral unit is readily implemented in hardware and software well within the purview of one of ordinary skill in the art. For example, the portable wireless link 101 of the portable security system 100 may be a cellular telephone. Alternatively, the portable wireless link 101 may be personal digital assistant (PDA) that is adapted to communicate via a wireless network, such as a cellular network, or other device in such a network. Still alternatively, the portable wireless link 101 may be a wireless station (STA) of a wireless local area network (WLAN). As is well known, STAs may be PDAs, or portable computers (e.g., laptop computers), as well as many other such portable devices.

Illustratively, the WLAN may be a network operating under IEEE 802.11 protocol or any of its progeny, or a Bluetooth network, or a Zigbee network. In the illustrative embodiment comprising a WLAN, the receiver 107 may be a host or access point (AP) of the WLAN. Thus, upon activation of the alarm upon sensing motion, the STA sends a transmission (e.g., signal 106) to the AP. From this notification, the AP can alert security personnel so appropriate measures may be taken.

It is emphasized that the various types of portable wireless links useful for portable wireless link 101 described herein are merely illustrative and that other types of portable wireless links that foster portability of the security system 100 are contemplated. Moreover, because many of the details of the illustrative portable wireless links are well-known to one of ordinary skill in the art, details of the hardware and software of these links are not described in detail to avoid obscuring the description of the example embodiments.

In the example embodiment described in connection with FIG. 1, the portable motion sensor 102 may comprise an active sensor or a passive sensor. Illustratively, the portable motion sensor 102 may comprise an ultrasonic motion sensor, a microwave motion sensor, an infrared motion sensor, or other motion sensor that is adapted to transmit mechanical or electromagnetic waves, and to receive reflections of these waves.

In illustrative embodiments where the portable motion sensor 102 comprises an active motion sensor, the beam 104 is comprised of waves having a predetermined frequency. These waves are transmitted toward the door or other object of the security measure. If no motion occurs, the waves are reflected back from the surrounding environment at substantially the same frequency as they are transmitted. This creates a signature of the reflected waves. However, if motion occurs in the surrounding environment, a Doppler shift occurs in the reflected waves. This shift results in a change in the signature of the reflected signal. The portable motion sensor 102 includes circuitry (not shown) to measure the shift in the signal. The portable motion sensor then communicates the shift in the signal to the alarm circuitry 105, which indicates that an intrusion has occurred.

As described previously, the portable security system 100 may be used in hotel rooms, apartments and dormitories. In such applications, the portable motion sensor 102 has a range and angular breadth (often referred to as a field of awareness) commensurate with confined living quarters. Illustratively, the angular breadth of the beam 104 (and thus the portable motion sensor) is approximately 20 degrees to approximately 50 degrees and the range is approximately 15 feet to approximately 20 feet. Many of the types of sensors described previously are adept at functioning within such a field of awareness.

In many applications, electrical power in the portable wireless link 101 comprising the portable motion sensor 102 may be at a premium. To this end, the portable security system 100 is beneficially portable. Often, the chosen power source for the portable security system 100 will be a battery or other DC power source. In order to conserve the power of the battery it is useful for the portable motion sensor 102 to have low operating power requirements. For example, in embodiments where the portable wireless link 101 is a cellular (mobile) phone or similar device, it is beneficial for the portable motion sensor 102 to require between approximately a few microwatts to approximately a few milliwatts of power so that it can operate for several hours using only battery power. Such low power consumption allows the portable security system 100 to be employed reliably in situations where security is needed for an extended period of time. The portable motion sensor 102 is not limited, however, to using battery power or other source of DC power. A number of alternative power sources, such as AC power, or even a solar cell, can be used to provide power to the portable motion sensor 102, while maintaining the portability of the security system 100.

As stated, the portable security system 100 may be implemented in a variety of environments and settings. Regardless of the environment in which the system 100 is used, it is necessary to provide the location of the system in the event that the alarm is activated. To wit, the signal 106 must convey the location of the system 100 to the receiver 107 so that appropriate measures may be taken. As described presently, the dissemination of location by the signal 106 may be effected in a variety of ways depending on preference, or the type of dwelling in which the system 100 is used, or both.

In certain example embodiments, the portable security system 100 may be used by persons in dwellings having a security staff or similar personnel, who receive the information at the receiver 107 and take appropriate action. For example, hotels, motels, cruise ships, dormitories and many apartment buildings have a security staff or department. These security departments may be co-located with the dwellings being monitored, or may be at a central location external to the dwelling (e.g., a centralized university police department). In accordance with an example embodiment, the location of the portable security system 100 may be encoded within a memory 108. Upon activation of the alarm circuitry 105, the transmitter 112 sends the signal 106, which includes the location of the system 100 from the memory 108. The encoding of the location into the memory may be effected in a variety of ways.

In certain illustrative embodiments, the transfer of the code to the holder of the system 100 may be carried out upon checking into a hotel or motel, when boarding a ship, or when taking possession of a dormitory or apartment. Illustratively, the code includes telephone number and a room code, where the telephone number may be that of the security department and the room code identifies the specific room of the hotel, motel or cruise ship, or the apartment or dormitory number.

Like electronic keys provided by many hotels, the code is only valid for the duration of the guest's (or dweller's) stay, after which it expires. Alternatively, the expiration of the code may be accomplished during a hotel checkout/lease surrender procedure, in which the code number is erased using a method similar to that used to program the code number into the portable wireless link 101 initially.

It is noted that in the event that the communication between the portable wireless link 101 and the receiver 107 is over a WLAN or other wireless network, the incorporation of a telephone number into the phone is unnecessary. Rather, the code indicating the location of the system may be sent over an appropriate channel of the network using the transmission and reception of signals appropriate for the wireless network being used.

Illustratively, the code number is entered into the memory 108. In the present example embodiment, the code number may be programmed into the system either manually (e.g., using the keypad on the portable wireless link 101) or by a non-wireless or a non-wireless method of electronic information transfer.

One way to encode the portable security system 100 in a non-wireless manner is via a transfer of electronic information using the system that encodes the key for the room or dwelling. For example, when the hotel or motel clerk provides the guest with an encoded key for the room, the transfer of the code to memory 108 may be effected by connecting the system 100 via a port 109 to the same database that provides the encoded room key. Similarly, upon taking possession of an apartment or dormitory, the code may be entered into the memory 108 in a like manner. Alternatively, the transfer of the code to memory may be effected by providing the guest with a removable memory card (e.g., a Trans-Flash™ card) that can be directly connected via the port 109. Upon check-out, or surrender of the leasehold, the guest/lessee can return the memory card as he/she would return the programmable keys that are commonly used.

As alluded to above, the code may be transferred to the memory 108 in a wireless manner. For example, the code may be transferred in to the memory 108 using the wireless system of the hotel, motel, cruise ship, apartment, or dormitory. In an example embodiment, the transmission of the code is from a transmitter 110 of the hotel, motel or other dwelling to a receiver 111 of the system 100. It is contemplated that the encoding in a wireless manner may be effected using one of a number of known wireless techniques. For example, if the portable wireless link 101 were a cell phone, the transmitter 110 could be the transmitter of a phone. Alternatively, the transmitter 110 may be a transmitter of an AP, and the receiver 111 may be the receiver of an STA. Of course, these examples are merely illustrative, and it is contemplated that the wireless transmission and reception of the code may be carried out using a variety of wireless devices, networks and protocols. These include, but are not limited to, devices and networks incorporating the IEEE 802.11 protocol and its progeny, the Bluetooth protocol and the Zigbee protocol.

It is emphasized that the methods of encoding the location of the system 100 and other useful information described above are merely illustrative. Clearly, the example embodiments contemplate other methods to perform this task.

In the example embodiments described in conjunction with FIG. 1, the portable security system 100 includes the portable motion sensor 102 integrated with the portable wireless link 101. This is useful in many applications. However, it may be desirable for the portable motion sensor to be detachable or otherwise separated from the portable wireless link. For example, it may be desirable to have the portable motion sensor separated from the portable wireless link, so the portable wireless link may be used while the portable motion sensor is in security mode. Thereby the user may avail herself/himself of the portable wireless link without risking setting off an alarm and while benefiting from the security system.

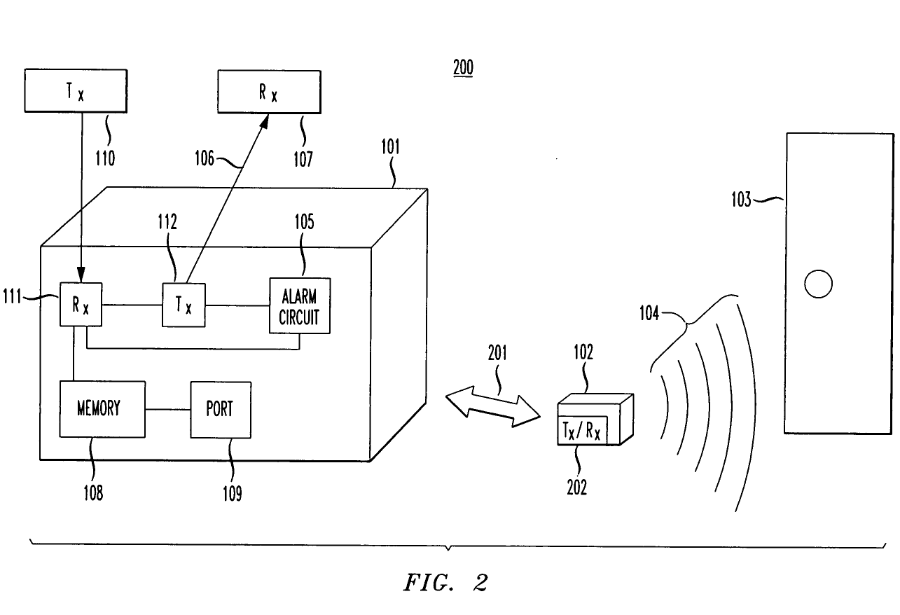

FIG. 2 is a block diagram of a portable security system 200 according to another example embodiment. It is noted that there are many features common to the portable security system of the example embodiments described in connection with FIG. 1 and those described presently in connection with FIG. 2. Many of these common features are not repeated so as to avoid obscuring the description of the present example embodiments.

In the present example embodiment, the portable motion sensor 102 and portable wireless link 101 are separated during use of the system. For example, the portable motion sensor 102 may be adapted to attach/detach mechanically from the portable wireless link 101. Illustratively, the portable wireless link 101 is located in one area or separate room, while the portable motion sensor 102 is located near the door 103 of the dwelling.

In operation, after the code is input to the memory 108 of the portable wireless link 101, the portable motion sensor 102 is disposed within proximity of the door 103. After the code is received into memory, security mode may then be engaged.

The engaging of security mode occurs via a similar method as described in connection with the example embodiment of FIG. 1, except that the communication between the portable motion sensor 102 and the memory 108 is via a signal 201 between the transmitter 112 of the portable wireless link 101 and a transceiver 202 of the portable motion sensor 102. As will become clearer as the present description, the signal 201 may be one of a variety of signal types between the portable wireless link 101 and the portable motion sensor 102.

The transceiver 202 includes transmission/receiver circuitry required to effect wireless communication between the portable motion sensor 102 and the portable wireless link 101. Illustratively, security mode is engaged by the transmission of the signal 201 (in this case the control signal) from the portable wireless link 101 to the portable motion sensor 102. It is noted that by a procedure similar to that described to engage the security mode, the security mode may be disengaged. Moreover, the control signal may be used alter the sensitivity or breadth of the portable motion sensor 102.

After security mode is engaged, the transmission of waves 104 and the reception of their reflections begin. In the event that the portable motion sensor 102 detects motion at the entrance, the signal 201 is sent to the receiver 111 and then to the alarm circuitry 105. The alarm circuitry 105 then initiates the transmission of the signal 106 from the transmitter 112 to the receiver 107.

The signal 201 is communicated in a wireless manner from the transceiver 202 of the portable motion sensor 102 to the portable wireless link 101. Beneficially, the transceiver 202 is compliant with the portable wireless link 101. To wit, the transceiver 202 functions according to the same wireless protocol as the portable wireless link 101. Illustratively, and as described in connection with the example embodiments of FIG. 1, the portable wireless link 101, and thus the link between the portable wireless link 101 and the portable motion sensor 102 operate under one of the protocols previously described.

Alternatively the signal 201 may be an infrared signal. Thus, the link between the portable motion sensor 101 and the portable wireless link 102 would be governed by an infrared communication protocol. It is noted that if the signal 201 is an infrared signal, the portable wireless link 101 generally has to be within the line of sight of the portable motion sensor 102. It is emphasized that the implementations of the wireless connection between the portable motion sensor 102 and the portable wireless link 101 are merely teaching examples and that those of ordinary skill in the art will recognize that there are many alternative ways to implement the wireless connection.

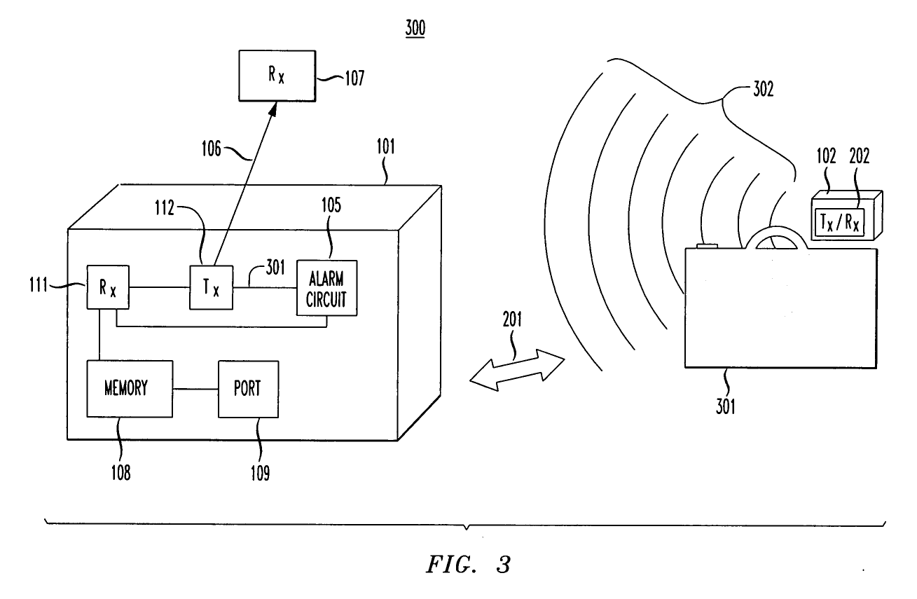

FIG. 3 is a diagram showing a portable security system 300 in accordance with yet another example embodiment. The portable security system 300 includes the portable wireless link 101 and the portable motion sensor 102. The portable wireless link 101 and the portable motion sensor 102 share many features with the portable security system of the example embodiments described in connection with FIGS. 1 and 2. Many of these common features are not repeated so as to avoid obscuring the description of the present example embodiments.

Beneficially, the portable security system 300 is poised to protect an individual's personal effects. Illustratively, these personal effects include a wide variety of personality; for example, luggage. As described in detail herein, when the personal effects are disturbed or motion is otherwise detected in the motion detector's field of awareness, an alarm notifies appropriate personnel that a security breach has occurred.

In operation, the portable wireless link 101 is placed near an item 301 to be protected and the portable motion sensor 102 is disposed over the item 301. The security mode is engaged by methods described previously, and the portable motion sensor 102 is in an active mode. In one example embodiment, the portable motion sensor 102 is sensitive to acceleration caused by movement or other physical contact. Thus, if one were to touch the item 301, the portable motion sensor 102 would be activated. The portable motion sensor 102 of such an embodiment may be one of a variety of passive sensor devices, including, but not limited to piezoelectric movement sensors and various known types of accelerometers.

If motion is detected, the portable motion sensor 102 transmits signal 201 to the portable wireless link 101 in a manner similar to that described in connection with the example embodiment of FIG. 2. The portable wireless link 101 then transmits signal 106 to the receiver 107. This will alert the security personnel that the item 301 has been tampered.

In another example embodiment, the portable wireless link 101 is not left near the item 301, but rather is carried by the owner of the item 301. In the event that the item 301 is disturbed, the signal 201 is transmitted to the portable wireless link 101, alerting the owner to the security. In addition, the security personnel may be notified via the portable wireless link in a manner previously described. This embodiment may be useful when the item must be left in a public location (e.g., a suitcase in an airport terminal) momentarily not under the watchful eye of the owner. If a would-be thief were to touch the item 301, at least the owner is alerted.

In addition to the methods of notifying of a security breach to item 301 described, an audible alarm 302 may be provided from the portable motion sensor 102. As can be appreciated, this alarm 302 will alert others in the vicinity of a breach of security of the item 301.

In view of this disclosure it is noted that various methods and components described in conjunction with a portable security system of the example embodiments can be implemented in hardware and software. Furthermore, the various methods, devices and parameters are included by way of example only and not in any limiting sense. In view of this disclosure, those skilled in the art can implement the various example devices and methods in determining their own techniques and needed equipment to effect these techniques, while remaining within the scope of the appended claims.

1. A portable security system, comprising:
a portable wireless link;
a portable motion sensor, which is adapted to receive control signals from the portable wireless link, and which is adapted to communicate a signal when a security breach occurs; and
a memory, which is adapted to receive a code indicating the location of the portable motion sensor.

2. A portable security system as recited in claim 1, wherein the portable motion sensor and the portable wireless link are integrated.

3. A portable security system as recited in claim 1, wherein the portable motion sensor and the portable wireless link are separated.

4. A portable security system as recited in claim 3, wherein the portable motion sensor comprises a transceiver adapted to transmit the signal to the portable wireless link and to receive the control signals from the portable wireless link.

5. A portable security system as recited in claim 1, wherein the portable wireless link is one of: a mobile telephone, a personal digital assistant (PDA) or a portable computer.

6. A portable security system as recited in claim 1, further comprising a port, which is adapted to receive the code and to transfer the code to the memory.

7. A portable security system as recited in claim 1, wherein the portable wireless link includes a receiver that is adapted to receive the code and to transfer the code to the memory.

8. A portable security system as recited in claim 1, wherein the portable wireless link is associated with a wireless network.

9. A portable security system as recited in claim 8, wherein the portable motion sensor is associated with the wireless network.

10. A portable security system as recited in claim 1, wherein the portable motion sensor is adapted to transmit a beam.

11. A portable security system as recited in claim 1, wherein the portable motion sensor is one of: an ultrasonic sensor, a microwave sensor, a millimeter wave sensor, a piezoelectric sensor, an accelerometer, or an infra-red sensor.

12. A portable security system as recited in claim 10, wherein upon movement of an object into a path of the beam, the signal is sent from the portable motion sensor to the portable wireless link.

13. A portable security system as recited in claim 12, wherein the movement of the object causes a Doppler shift in the beam.

14. A portable security system as recited in claim 1, wherein the control signals are one or more of:
engagement signals, disengagements signals and sensitivity alteration signals.

15. A portable security system as recited in claim 5, wherein personal wireless link is associated with a wireless network and the security breach is communicated to an access point (AP).

16. A portable security system as recited in claim 1, wherein the code includes a telephone number of a security department, and the portable wireless link calls the security department in the event of the security breach.

17. A method of providing security, the method comprising:
providing a portable wireless link and a portable motion sensor;
transmitting control signals from the portable wireless link;
providing a code to the portable wireless link, wherein the code includes a location of the portable motion sensor; and
communicating a signal from the portable wireless link when a security breach occurs.

18. A method as recited in claim 17, wherein the providing the code comprises transmitting the code from a transmitter.

19. A security method as recited in claim 17, wherein the portable motion sensor and the portable wireless link are integrated.

20. A security method as recited in claim 17, wherein the portable motion sensor and the portable wireless link are separated.
